(19) United States
(12) Patent Application Publication
(10) Pub. No.: US 2003/0141062 A1
(43) Pub. Date: Jul. 31, 2003

(54) Method for decreasing lost circulation during well operations using water absorbent polymers

(76) Inventors: Jack C. Cowan, Lafayette, LA (US); Michael J. Kilchrist, Lafayette, LA (US); Robin J. Verret, Youngsville, LA (US)

Correspondence Address: Roy F. House, 5726 Ettrick Drive, Houston, TX, 77035, US

(21) Appl. No.: 10/351,859

(22) Filed: Jan. 27, 2003

Related U.S. Application Data
(60) Provisional application No. 60/353,101, filed on Jan. 30, 2002.

(51) Int. Cl. E21B 33/138; C09K 7/02

(52) U.S. Cl. 166/294; 166/300; 175/72; 507/104; 507/110; 507/145; 507/204; 507/211; 507/277

(57) ABSTRACT

Disclosed is a method and gellable composition for decreasing the loss of fluid during well drilling or servicing operations. The gellable composition comprises a superabsorbent polymer in an acidic aqueous liquid in which the superabsorbent is not swellable. Preferably the gellable composition also contains a viscosifier, preferably chitosan. The method is practiced by forming the gellable composition, placing it at the location of fluid loss in a well, and mixing it with a basic aqueous liquid to raise the pH and thus allow the superabsorbent to expand in volume. Advantageously, the superabsorbent, chitosan, and an acid, preferably a solid acid, preferably sulfamic acid, are admixed to form an additive for preparing the gellable composition.

This patent application claims priority to U.S. Provisional Patent Application No. 60/353,101 filed Jan. 30, 2002 whose applicants and title are the same as for this utility patent application.

### BACKGROUND OF THE INVENTION

The invention concerns a method for reducing lost circulation when aqueous or oil based drilling fluids are used. More particularly, the method involves dispersing a water absorbent polymer in an acidic aqueous liquid which will prevent the polymer from absorbing water and expanding to plug fissures and thief zones until water absorption is desired.

Drilling fluids, or drilling muds as they are sometimes called, are generally slurries of clay solids or polymers used in the drilling of wells in the earth for the purpose of recovering hydrocarbons and other fluid materials. Drilling fluids have a number of functions, the most important of which are: lubricating the drilling tool and drill pipe which carries the tool, removing formation cuttings from the well, counterbalancing formation pressures to prevent the inflow of gas, oil or water from permeable rocks which may be encountered at various levels as drilling continues, and holding the cuttings in suspension in the event of a shutdown in the drilling and pumping of the drilling fluid.

For a drilling fluid to perform these functions and allow drilling to continue, the drilling fluid must stay in the borehole. Frequently, undesirable formation conditions are encountered in which substantial amounts or, in some cases, practically all of the drilling fluid may be lost to the formation. Drilling fluid can leave the borehole through large or small fissures or fractures in the formation or through a highly porous rock matrix surrounding the borehole.

Most wells are drilled with the intent of forming a filter cake of varying thickness on the sides of the borehole. The primary purpose of the filter cake is to reduce the large losses of drilling fluid to the surrounding formation. Unfortunately, formations conditions are frequently encountered which may result in unacceptable losses of drilling fluid to the surrounding formation despite the type of drilling fluid employed and filter cake created.

A variety of different substances may be pumped down well bores in attempts to reduce the large losses of drilling fluid to fractures and the like in the surrounding formation. Different forms of cellulose are the preferred materials employed. Some substances which have been pumped into well bores to control lost circulation are: almond hulls, walnut hulls, bagasse, dried tumbleweed, paper, coarse and fine mica, and even pieces of rubber tires.

Another process that is employed to close off large lost circulation problems is referred to in the art as gunk squeeze. In the gunk squeeze process, a quantity of a powdered bentonite is mixed in diesel oil and pumped down the well bore. Water injection follows the bentonite and diesel oil. If mixed well, the water and bentonite will harden to form a gunky semi-solid mess, which will reduce lost circulation. Problems frequently occur in trying to adequately mix the bentonite and water in the well. The bentonite must also be kept dry until it reaches the desired point in the well. This method is described in U.S. Pat. No. 3,062,823.

Many of the methods devised to control lost circulation involve the use of a water expandable clay such as bentonite which may be mixed with another ingredient to form a viscous paste or cement. U.S. Pat. No. 2,890,169 discloses a lost circulation fluid made by forming a slurry of bentonite and cement in oil. The slurry is mixed with a surfactant and water to form a composition comprising a water-in-oil emulsion having bentonite and cement dispersed in the continuous oil phase. As this composition is pumped down the wellbore, the oil expands and flocculates the bentonite, which, under the right conditions, forms a filter cake on the wellbore surface in the lost circulation area. Hopefully, the filter cake will break the emulsion causing the emulsified water to react with the cement to form a solid coating on the filter cake. But such a complex process can easily go wrong.

U.S. Pat. No. 3,448,800 discloses another lost circulation method wherein a water soluble polymer is slurried in a nonaqueous medium and injected into a well. An aqueous slurry of a mineral material such as barite, cement or plaster of paris is subsequently injected into the well to mix with the first slurry to form a cement-like plug in the wellbore.

U.S. Pat. No. 4,261,422 describes the use of an expandable clay such as bentonite or montmorillonite which is dispersed in a liquid hydrocarbon for injection into the well. After injection, the bentonite or montmorillonite will expand upon contact with water in the formation, thus, it is hoped that the expanding clay will close off water producing intervals but not harm oil producing intervals.

A similar method is disclosed in U.S. Pat. No. 3,078,920 which uses a solution of polymerized methacrylate dissolved in a nonaqueous solvent such as acetic acid, acetic anhydride, propionic acid and liquid aliphatic ketones such as acetone and methylethyl ketone. The methacrylate will expand upon contact with formation water in the water producing intervals of the well.

It has also been proposed to mix bentonite with water in the presence of a water soluble polymer which will flocculate and congeal the clay to form a much stronger and stiffer cement-like plug than will form if bentonite is mixed with water. U.S. Pat. No. 3,909,421 discloses such a fluid made by blending a dry powdered polyacrylamide with bentonite followed by mixing the powdered blend with water. U.S. Pat. No. 4,128,528 claims a powdered bentonite/polyacrylamide thickening composition prepared by mixing a water-in-oil emulsion with bentonite to form a powdered composition which rapidly becomes a viscous stiff material when mixed with water. U.S. Pat Nos. 4,503,170; 4,475,594; 4,445,576; 4,442,241 and 4,391,925 teach the use of a water expandable clay dispersed in the oily phase of a water-in-oil emulsion containing a surfactant to stabilize the emulsion and a polymer dispersed in the aqueous phase. When the emulsion is sheared, it breaks and a bentonite paste is formed which hardens into a cement-like plug. The patent discloses the use of such polymers as polyacrylamide, polyethylene oxide and copolymers of acrylamide and acrylic or methacrylic acid.

U.S. Pat. No. 4,124,748 discloses a cross-linked co-polymer of a vinyl ester and an ethylenically unsaturated carboxylic acid or derivative thereof that can absorb 200-800% of its weight in water and expand substantially in volume when doing so. Another highly water absorbent, expanding copolymer is described in U.S. Pat. No. 4,230,040. The described compound is derived by polymerizing acrylic acid and/or methacrylic acid in the presence of polyvinyl alcohol followed by neutralization and heat treatment.

U.S. Pat. No. 4,635,726 discloses the use of superabsorbent polymers dispersed or suspended in a liquid hydrocarbon for injection into a well and placed at the location where lost circulation is occurring. After placement and upon mixing with water, the superabsorbent polymer expands thus decreasing the loss of fluid from the wellbore.

U.S. Pat. Nos. 4,664,816, 4,836,940, 5,034,139 and 5,086,841 disclose various methods of utilizing water absorbent polymers to decrease the loss of circulation fluid in a wellbore.

### SUMMARY OF INVENTION

The invention is a novel method for reducing lost circulation when aqueous or oil based drilling fluid are used. It involves the use of one or more water absorbent polymers dispersed in an acidic aqueous liquid which are injected into the wellbore and lost circulation zone. The acidic aqueous liquid prevents the polymers from absorbing water until the pH is subsequently increased. Once the acidic aqueous liquid containing the polymer is properly placed at the lost circulation zone, a base is mixed with the liquid so that the polymer will expand with the absorbed water and substantially increase in size to close off the lost circulation zone.

The acidic aqueous liquid containing a dispersed water absorbent polymer is injected into the wellbore and spotted at the lost circulation thief zone. Preferably, a slug of an alkaline aqueous fluid is injected to mix with the fluid and come into contact with the water absorbent polymer. Alternately, an alkaline aqueous drilling fluid can be mixed with the acidic aqueous liquid and the polymer in the lost circulation zone. A final step is circulating the drilling fluid or otherwise removing undesired compounds from the borehole.

The invention also comprises an additive for preparing a gellable composition to combat lost circulation in a subterranean thief zone which comprises a superabsorbent polymer, chitosan, and an acid, preferably a solid acid.

It is therefore a general object of the invention to provide improved compositions for sealing subterranean thief zones and methods of using the compositions to decrease the loss of fluid in a wellbore during well drilling and servicing operations.

These and other objects of this invention will be apparent to one skilled in the art upon reading this specification and the appended claims.

While the invention is susceptible of various modifications and alternative forms, specific embodiments thereof will hereinafter be described in detail and shown by way of example. It should be understood, however, that it is not intended to limit the invention to the particular forms disclosed, but, on the contrary, the invention is to cover all modifications and alternatives falling within the spirit and scope of the invention as expressed in the appended claims.

The compositions can comprise, consist essentially of, or consist of the stated materials. The method can comprise, consist essentially of, or consist of the stated steps with the stated materials.

### DETAILED DESCRIPTION

Drilling fluids are formulated to intentionally seal porous formations during drilling in order to stabilize the borehole and to control fluid loss. However, formations are frequently encountered that are so porous as to increase the loss of drilling fluids beyond an acceptable limit despite the use of lost circulation additives. Furthermore, a borehole may penetrate a fracture in the formation through which most of the drilling fluid may be lost.

In order to close off large pores and fractures which drain drilling fluid from the borehole, it is necessary to place the lost circulation material at the proper location and to be able to clean up the wellbore after treatment is completed. The present invention offers a method for accomplishing this in a borehole whether the well is being drilled with aqueous drilling fluids or oil based drilling fluids. The invention involves the use of a polymer which expands substantially in volume when absorbing water. An acidic aqueous liquid carrier fluid is used to place the polymer at and in the lost circulation zone. Contact with a base or high pH alkaline fluid results in water absorption by the polymer, causing the polymer to increase significantly in size, blocking off the lost circulation zone. Mixing with a high pH alkaline fluid may be brought about by the use of a separate slug of a high pH alkaline fluid, or if an alkaline aqueous drilling fluid is being used, by mixing the drilling fluid with the acidic aqueous liquid and the polymer dispersed therein.

Any polymer which will significantly increase in size after absorption of water at a basic pH may be dispersed within the acidic aqueous liquid to practice the present invention. A class of water absorbent polymers known as superabsorbent polymers perform very well.

Superabsorbent polymers absorb many times their own weight in water, causing the polymer volume to drastically expand. Several of these preferred highly water absorbent polymers are alkali metal polyacrylates including J-500 and J-550, trademarked sodium polyacrylate polymers sold by Grain Processing Co.; A-100, a trademarked starch graft copolymer of polyacrylic acid and polyacrylamide sold by Grain Processing Co.; A-400, a trademarked polyacrylamidecosodium acrylate sold by Grain Processing Co.; and B-200, a trademarked potassium salt of A-400 sold by Grain Processing Co.

The amount of water these superabsorbent polymers will absorb is astounding. The J-500 polymer will absorb 375 ml of water per gram of J-500 polymer. The A-100 polymer will suck up 140 ml of water per gram of polymer. However, salt water has an adverse effect on water absorption. The addition of 0.4% NaCl to water will decrease the absorption of A-100 to 55 ml of water per gram of A-100 and decrease absorption of J-500 from 375 ml to 100 ml of water per gram of J-500.

Another group of water absorbent polymers which perform well in the invention are prepared by polymerizing one or more of the acids from the group consisting of acrylic acid and methacrylate acid in the presence of polyvinyl alcohol, neutralizing the polymer, and heat treating the polymer at about 50° C. to about 150° C. These polymers may also be cross-linked by carrying out the polymerization in the presence of a cross-linking agent. The hydrophilic gel polymers prepared accordingly to the method are disclosed in U.S. Pat. No. 4,230,040, the disclosure of which is incorporated herein by reference. Starch graft copolymers are well known superabsorbents. See for example U.S. Pat. No. 3,976,552; 3,981,100; 4,155,888; 5,032,659; and 5,525,690, all incorporated herein by reference.

Surface-treated superabsorbent polymers particles are disclosed in U.S. Pat. No. 6,239,230. Other synthetic superabsorbent polymers are disclosed in U.S. Pat. Nos. 4,043,952; 4,914,170; 5,461,085; 5,986,042; and 6,072,024, all incorporated herein by reference.

All of these polymers expand substantially in size upon water absorption and absorb many times their weight in water.

Saponified copolymers of a vinyl ester and a compound selected from the group consisting of ethylenically unsaturated carboxylic acids and derivatives of ethylenically unsaturated carboxylic acids may also be employed. U.S. Pat. No. 4,124,748, the disclosure of which is incorporated herein by reference, states that these copolymers may also be cross-linked by polymerizing in the presence of a cross-linking agent. The cross-linking agent may include polyallyl compounds such as diallyl phthalate, diallyl maleate, diallyl tetraphthalate, triallyl cyanuorate or triallyl phosphate, polyvinyl compounds such as divinyl benzene, N,N′-methylene-bis-acrylamide, ethylene glycol diacrylate, ethylene glycol dimethacrylate or glycerine trimethacrylate, allyl acrylate and allyl methacrylate. As the degree of cross-linking is increased with an increase in the amount of crosslinking agent, the water absorbing ability decreases. Thus, only a moderate amount of cross-linking is desired. These polymers increase significantly in size when absorbing as much as ten times their own weight in water. Furthermore, their gel formation ability is stable in a hydrated state for a long period of time.

If the polymer is structurally weak, a substrate may be used to help the support the polymer. Of course, other compounds which absorb water and expand in size which are not mentioned herein may also be used to control lost circulation according to the invention.

The most preferred method of practicing the invention involves the injection of a discrete slug (or “pill”) of acidic aqueous liquid (hereinafter sometimes referred to as “AAL”) containing the superabsorbent polymer therein into the wellbore, wherein the AAL slug contains the water absorbent polymer in a proportion sufficient to seal off the lost circulation zone upon contact with a base. Depending on the polymer and the composition of the AAL slug, about 1 to about 10 pounds of water absorbent polymer per barrel, more preferably, about 2 to about 5 pounds of polymer per barrel, can be incorporated within the AAL slug. The AAL slug is also referred to herein as a “gellable composition.”

Preferably the AAL slug will additionally contain a viscosifier to increase the viscosity and suspension characteristics of the AAL slug. This will maintain the superabsorbent polymer dispersed throughout the AAL slug during storage and downhole placement thereof. Representative viscosifiers are polysaccharides, particularly biopolymers such as xanthan gum and scleroglucan gum, and chitosan and derivatives thereof. Generally the concentration of the viscosifier will be from about 1 to about 10 pounds per 42 gallon barrel of the AAL.

The AAL slug with polymer therein is spotted at the lost circulation zone and preferably, forced into the lost circulation zone by pumping. Depending on the character and size of the lost circulation zone, as little as 100 gallons of the slug and polymer may be needed. Preferably, an aqueous spacer fluid or slug is employed as a spacer between the polymer slug from the alkaline drilling fluid to insulate the polymer slug from the alkaline drilling fluid and to force the slug and polymer into the lost circulation zone. Alternately, a basic high pH alkaline fluid (hereinafter sometimes referred to as “BAF”) slug, or the alkaline aqueous drilling fluid or an oil based drilling fluid, may be used to force the polymer into the lost circulation zone. If the well is being drilled with an aqueous mud, it is also preferred to employ a viscous aqueous slug without superabsorbent polymer as a spacer between the AAL slug and the BAF slug, and preferably also before the AAL slug and after the BAF slug to prevent any dilution of these slugs. These spacer slugs will prevent the BAF slug from mixing with the AAL slug and expanding the polymer prior to entry of the polymer into the lost circulation zone.

When the BAF comes into intimate contact with the AAL slug containing the polymer, the polymer will absorb the water and expand in the formation and borehole, closing off the lost circulation zone. After a brief setting time, the undesired compounds may be circulated out of the borehole. It is a preferred practice to raise the drill stem and bit above the lost circulation zone so that after the lost circulation zone is sealed off, the drill stem and bit can be brought back down to flush and clean the expanded polymer from the wellbore.

If a clay based alkaline aqueous drilling mud is used to expand the polymer instead of a clay-free alkaline fluid, the seal provided by the mixture of expanded polymer and clay will be firmer and more permanent than if the polymer alone was present. However, the use of the water expanded polymer without clay is sufficient to seal off most lost circulation zones.

The polymer particles may be sized over a wide range. The size of the passages through the circulating jets in the drill bit is the absolute maximum particle size. However, the polymer should be of a small enough size so as to be able to enter the formation through fissures, small fractures and large pores. A preferred range of particle size is about 0.1 microns to 5 millimeters. The particles should be sized according to the properties of the formation and the lost circulation zone.

If the polymer is set with a clay free water and it is desired to reverse the treatment, it is only necessary to pump salt water into the borehole. Upon contact with salt water the expanded polymer will break up and release most of its absorbed water. The formerly expanded polymer can then be washed out of the formation. The preferred superabsorbent polymers encapsulated for this invention absorb only one-fourth to one-third as much salt water as fresh water when the salt water concentration is 0.4% NaCl. Higher salt concentrations result in even less salt water absorption. Thus, the use of fresh water in expanding the polymer is preferred.

Any AAL may be employed as a carrier fluid if it will not degrade the superabsorbent polymer. Thus aqueous acidic liquids containing inorganic acids or organic acids can be the carrier fluid. Representative non-limiting acids include hydrochloric acid, sulfamic acid, carboxylic acids containing from 1 to 6, preferably 1 to 3 carbon atoms, sulfonic acids containing from 1 to 6 carbon atoms, preferably 1 to 3 carbon atoms, and the like. Particularly preferred is sulfamic acid. Sulfamic acid is a solid and can be admixed with the superabsorbent polymer to provide an additive which can be added to an aqueous liquid to produce the AAL slug or pill for placement in a borehole. Preferably the AAL slug will have a pH less than about 4.5, most preferably less than about 4.0.

It is important not to use too large of an excess of a BAF to expand the polymer. The intent is to get a viscous thick mixture. Excess BAF will thin the mixture, decreasing its sealing effect. Appropriate ratios of AAL to BAF can easily be determined before placing the slugs in the borehole.

The gellable composition may also contain other materials which also aid in relieving lost circulation during drilling or the loss of fluid during well servicing. Thus the gellable composition may also contain any of the known such materials, generally called “LCM.” These include bagasse, flax, straw, ground hemp, shredded paper, paper pulp, cellophane strips, ground plastics, mica flakes, expanded perlite, silica slag, diatomaceous earth, ground bark, cottonseed hulls, cotton linters, nut hulls or shells, seed husks, and the like. As indicated, a vast assortment of materials have been used in drilling fluid compositions as formation sealing agents to seal high permeability thief formations in attempts to restore lost circulation of the drilling fluid when a lost circulation condition has been encountered. It is preferred that finely ground paper be incorporated into the gellable composition as needed for additional sealing.

The gellable composition may also contain any of the known weight materials, preferably barite, to increase the density of the gellable composition if necessary as is well known in the art.

Usually, it is immediately apparent when a fracture is penetrated by the wellbore. The mud pressure will drop and less drilling fluid will be circulated back to the top of the hole. Large fractures can be responsible for draining off almost all of the drilling fluid. When this occurs, the AAL slug containing the polymer should be injected into the wellbore and spotted at the lost circulation zone. Then one of several alternative procedures may be followed, with some steps depending upon whether an aqueous drilling fluid or an oil based drilling fluid is being used.

In one method, the AAL slug and polymer is pumped down the tubing and back up the annulus to the lost circulation zone. This may be done by adding the AAL and polymer slug to an aqueous drilling fluid so that drilling fluid precedes and follows the AAL slug. Once the polymer is properly spotted, the annulus is closed off near the surface. This may be accomplished by closing the rams in the blowout preventer. Pumping of the drilling fluid down the tubing string and back up the annulus of the borehole is resumed to force the hydrocarbon slug into the lost circulation zone. If an aqueous drilling fluid is used, this will also cause the drilling fluid to mix with the hydrocarbon slug and polymer in the lost circulation zone, triggering the expansion of the polymer and sealing off of the lost circulation zone.

Another method is to pump the AAL slug down the tubing string and back up the annulus to the lost circulation zone, while pumping a BAF down the annulus to meet with the AAL slug at the lost circulation zone. Pressure can be applied to both the AAL and the BAF slugs to force both fluids into the lost circulation zone, where mixing and polymer expansion will occur. Another method is to spot the AAL and polymer slug at the lost circulation zone and then inject a BAF through the tubing string directly to the lost circulation zone to mix with the AAL polymer slug. Of course, other methods known in the art may also be used to mix the BAF with the AAL and polymer slug at the location of the lost circulation zone.

There is disclosed in co-pending U.S. patent application Ser. No. 09/898856 filed Jul. 3, 2001, incorporated herein by reference, a process of reducing the loss of fluid into flow passages of a subterranean formation during well drilling, completion, or workover operations comprising introducing into the flow passages an aqueous liquid comprising water, a partially hydrated chitosan the particles of which have been partially hydrated in the water at an acidic pH less than about 4.5, and a base to raise the pH of the liquid above about 6.5, most preferably above about 8.0.

We have now found that incorporating a superabsorbent polymer in the acidic chitosan-containing fluid further decreases the loss of fluid from the fluid present in a borehole. Thus upon raising the pH above about 8.0 of a slug or pill of an aqueous acidic liquid containing both chitosan and a superabsorbent polymer, a polymer plug is formed at the location of the loss of fluid in a borehole after placement of the slug therein. Such an AAL slug will preferably contain from 3 to about 10 pounds per 42 gallon barrel of chitosan and from about 2 to about 10 pounds per 42 gallon barrel of the superabsorbent polymer.

In accordance with another preferred embodiment of the invention, an additive comprising a solid mixture of the chitosan, superabsorbent polymer, and a solid acid such as sulfamic acid can be provided which, when mixed with an aqueous liquid, will produce an AAL slug for placement in a borehole. The preferred weight ratio of chitosan: superabsorbent polymer: sulfamic acid is within the range of 30%-55% chitosan, 20%-50% superabsorbent polymer, and 10%-40% sulfamic acid. The preferred chitosan has a degree of acetylation from 0% to about 40%.

The AAL slug preferably contains from about 5 pounds per 42 gallon barrel to about 25 pounds per 42 gallon barrel of the additive.

The following examples will further illustrate the novel lost circulation additive and inventive method of the present invention. These examples are given by way of illustration and not as a limitation of a scope of the invention. Thus, it should be clearly understood that the inventive additive and method may be varied to achieve similar results within the scope of the invention.

In these examples and in this specification the following abbreviations may be used: bbl=42 gallon barrel; ppb=pounds per 42 gallon barrel; lb=pound(s); ppg=pounds per gallon; LC=lost circulation; LCM=lost circulation material.

### EXAMPLE 1

During drilling operations a lost circulation thief zone is entered which consumes 50 to 100 barrels/hour of the drilling fluid. A gellable composition is prepared by mixing into fresh water ten (10) pounds per 42 gallon barrel of an additive comprising 30% by weight of a superabsorbent polymer, ENVIROSORB®, obtained from Stockhausen, Inc., 40% by weight of chitosan having a degree of acetylation of about 30% obtained from ChitinWorks America, and 30% by weight sulfamic acid in a clean tank. The mixing is continues for about one hour in order to allow the chitosan to partially hydrate thus increasing the viscosity. Sufficient barite is then added to provide the gellable composition with a density of 10.5 pounds per gallon. The pH of the gellable composition is about 3.0.

The gellable composition is then pumped through the drill pipe, the bottom of which is positioned just above the loss zone or at the casing shoe, and into the loss zone. The gellable composition is followed by sufficient aqueous solution of soda ash to provide the gellable composition with a pH of about 10 upon mixing therewith. The circulation of fluid is then interrupted for about four (4) hours during which time the superabsorbent swells in volume and the gellable composition gels. Thereafter the circulation of the drilling fluid proceeds.

### EXAMPLE 2

A gelling, swelling sealing agent to overcome lost circulation was prepared by mixing together 40% by weight chitosan (obtained from ChitinWorks America), 30% by weight sulfamic acid, 15% of ENVIROSORB C superabsorbent polymer, and 15% of ENVIROSORB M superabsorbent polymer.

While drilling at 16,150 feet with a mud weight of 16.5 ppg, complete returns were lost. A conventional 100 bbl LCM pill was pumped without success. A 50 bbl lost circulation pill was prepared by mixing together 37 bbl fresh water, 50 lb sulfamic acid, 500 lb of the gelling, swelling sealing agent, and 22,500 pounds of barite weighting agent. This LC pill was pumped into the well followed by 3 bbl of 16.5 ppg water base mud (to serve as a spacer) and 100 bbl of a highly alkaline EZ SQUEEZE (Turbo-Chem International, Inc.) pill. The pressure was maintained 8 hours to allow the sealing agent to swell and the squeeze to bridge. Excess pill was circulated out of the borehole and drilling resumed with complete returns.

### EXAMPLE 3

While drilling at 16,379 feet with a mud weight of 16.9 ppg, complete returns were lost. A conventional 100 bbl LCM pill was pumped without success. A 50 bbl lost circulation pill was prepared by mixing together 33 bbl fresh water, 10 ppb of the gelling, swelling sealing agent of Example 2, 1 ppb sulfamic acid, 5 gallons of a liquid defoamer, and 23,900 pounds of barite. With the bit at the shoe, the LC pill was pumped to the bit followed by 75 bbl of a 16.9 ppg highly alkaline EZ SQUEEZE pill. The well was shut in and all 50 bbl of the LC pill and 35 bbl of the EZ SQUEEZE pill were pumped into the formation with an ending casing pressure of 500 psi. While holding pressure on the well for 3.5 hours, the casing pressure increased to 925 psi. Drilling resumed without further losses.

### EXAMPLE 4

While washing to the bottom of a well with an 8.6 ppg 2% KCl solution, returns were lost at the perforations. Well would not hold water. Ten barrels of an 8.6 ppg pill containing 12.5 ppb of the gelling, swelling sealing agent of Example 2 was mixed, spotted on bottom, and set for two days due to a holiday. Because of the long aging time the superabsorbent polymer was able to swell and the perforations were sealed. Tripped into borehole with a coil tubing unit and the remaining twenty feet of sand were washed out with full returns. The gelling, swelling sealing agent pill worked exceptionally well in sealing off the perforations in order to finish washing to bottom.

We claim:

1. A method of decreasing the loss of fluid in a wellbore to a subterranean thief zone in which well drilling or servicing operations are being conducted which comprises preparing a gellable composition comprising an acidic aqueous liquid and a superabsorbent polymer swellable at alkaline pH, introducing the gellable composition into the thief zone by way of the wellbore, and contacting the gellable composition with an alkaline fluid in an amount sufficient to provide the gellable composition with an alkaline pH.

2. The method of claim 1 wherein the gellable composition has a pH less than about 4.5.

3. The method of claim 1 wherein the alkaline pH is at least about 8.

4. The method of claim 1 wherein the gellable composition further comprises chitosan.

5. The method of claim 4 wherein the chitosan has a degree of acetylation of 0% to about 40%.

6. The method of claim 1 wherein the acidic aqueous liquid contains sulfamic acid therein.

7. The method of claim 4 wherein the acidic aqueous liquid contains sulfamic acid therein.

8. The method of claim 7 wherein the gellable composition contains the superabsorbent polymer, chitosan, and sulfamic acid in a weight ratio of 20% to 50% superabsorbent polymer, 30% to 55% chitosan, and 10% to 40% sulfamic acid, and wherein the total concentration of superabsorbent polymer, chitosan, and sulfamic acid is from about 5 pounds per 42 gallon barrel to about 25 pounds per 42 gallon barrel.

9. An additive for preparing a gellable composition to combat lost drilling fluid circulation in a subterranean thief zone which comprises a superabsorbent polymer chitosan, and an acid.

10. The additive of claim 9 wherein the acid is a solid.

11. The additive of claim 10 wherein the acid is sulfamic acid.

12. The additive of claim 9 wherein the chitosan has a degree of acetylation from bout 0% to about 40%.

13. The additive of claim 12 wherein the acid is a solid.

14. The additive of claim 12 wherein the acid is sulfamic acid.

15. The additive of claim 9 wherein the weight ratio of superabsorbent polymer, chitosan, and sulfamic acid is 20% to 50% superabsorbent polymer, 30% to 55% chitosan, and 10% to 40% sulfamic acid.
